(19) United States
(12) Patent Application Publication
(10) Pub. No.: US 2026/0210493 A1
(43) Pub. Date: Jul. 23, 2026

(54) METHOD OF FORMING A GRATING HAVING VARIABLE HEIGHT TRANSVERSE BARS

(71) Applicant: Ohio Gratings, Inc., Canton, OH (US)

(72) Inventor: Ryan Christopher HALLGREN, Clinton, OH (US)

(73) Assignee: Ohio Gratings, Inc., Canton, OH (US)

(21) Appl. No.: 19/032,341

(22) Filed: Jan. 20, 2025

(51) Int. Cl. F16S 3/08; E04C 2/42

(52) U.S. Cl. CPC F16S 3/08; E04C 2/425

(57) ABSTRACT

A grating having a plurality of bearing bars and a plurality of transverse bars which are orthogonally oriented to one another. The plurality of transverse bars includes a first transverse bar and a second transverse bar which differ in dimension from one another. Grating includes a plurality of slots defined in each of the plurality of bearing bars. Each of the plurality of transverse bars is receivable within a complementary slot of the plurality of slots. The plurality of slots includes a first slot and a second slot which differ in dimension from one another. A top of each of plurality of slots is offset a distance from a top of the bearing bar. Grating may include one or more additional transverse bars which differ in dimension from the first and second transverse bar and one or more additional slot which differ in dimension from the first and second slot.

### TECHNICAL FIELD

This disclosure is directed to grating installed in sidewalks or roads. More particularly, the present disclosure relates to a bar assembly and a grating incorporating the same.

### BACKGROUND ART

Gratings configured for supporting vehicle and/or pedestrian traffic are commonly used on sidewalks and road surfaces that require venting and/or drainage. Typically, gratings are configured to permit variously sized wheels and/or foot traffic to pass thereover without catching or presenting a hazard thereto. Additionally, because gratings are installed in areas where they are seen and not easily concealed, they are typically designed to be both functional and aesthetically pleasing.

Gratings are commonly configured to have a frame within which is installed a bar assembly. The bar assembly comprises a plurality of bearing bars which are typically arranged parallel to one another and laterally spaced at regular intervals one another. A plurality of transverse bars is arranged orthogonal to the bearing bars and connect the bearing bars to one another. In previously known gratings, the bearing bars tend to be rectangular in cross section. Additionally, the transverse bars tend to be rectangular in cross section and are uniformly sized and shaped relative to one another. The transverse bars are typically heavy and therefore relatively expensive to manufacture, ship, and install.

### SUMMARY OF THE INVENTION

The present disclosure is directed to a bar assembly comprising a plurality of bearing bars and a plurality of transverse bars, wherein the transverse bars are of variable heights.

A grating having a plurality of bearing bars and a plurality of transverse bars which are orthogonally oriented to one another. The plurality of transverse bars includes a first transverse bar and a second transverse bar which differ in dimension from one another. Grating includes a plurality of slots defined in each of the plurality of bearing bars. Each of the plurality of transverse bars is receivable within a complementary slot of the plurality of slots. The plurality of slots includes a first slot and a second slot which differ in dimension from one another. A top of each of plurality of slots is offset a distance from a top of the bearing bar. Grating may include one or more additional transverse bars which differ in dimension from the first and second transverse bar and one or more additional slot which differ in dimension from the first and second slot.

In one aspect, an exemplary embodiment of the present disclosure may provide a grating comprising a plurality of bearing bars and a plurality of transverse bars. The plurality of transverse bars is oriented orthogonal to the plurality of bearing bars. The plurality of transverse bars includes a first transverse bar and a second transverse bar. The first transverse bar and the second transverse bar differ in dimension from one another.

In another aspect, an exemplary embodiment of the present disclosure may provide where the first transverse bar is of a first height and the second transverse bar is of a second height and the second height is larger than the first height. In another aspect, an exemplary embodiment of the present disclosure may provide a plurality of slots defined in each of the plurality of bearing bars, where each of the plurality of transverse bars is receivable within a complementary one of the plurality of slot. In another aspect, an exemplary embodiment of the present disclosure may provide where the plurality of slots comprises a first slot and a second slot and where the first slot and the second slot differ in dimension. In another aspect, an exemplary embodiment of the present disclosure may provide where the first slot is of a first height and the second slot is of a second height and the second height is larger than the first height. In another aspect, an exemplary embodiment of the present disclosure may provide where the first slot is complementary in dimension to the first transverse bar. In another aspect, an exemplary embodiment of the present disclosure may provide where the second slot is complementary in dimension to the second transverse bar. In another aspect, an exemplary embodiment of the present disclosure may provide where one or more additional transverse bars which differ in dimension from the first transverse bar and the second transverse bar. One or more additional slots defined in the plurality of bearing bars which differ in dimension from the first slot and the second slot. Where the one or more additional slots are complementary in dimension to the one or more additional transverse bars. In another aspect, an exemplary embodiment of the present disclosure may provide where a plurality of slots defined in each bearing bar of the plurality of bearing bars. Where the bearing bar has a top and a bottom opposite one another and a top of each of the plurality of slots is offset a distance from the top of the bearing bar. In another aspect, an exemplary embodiment of the present disclosure may provide where the plurality of slots comprises a first slot and a second slot. Where the first slot is located a first offset from the top of the bearing bar and the second slot is located a second offset from the top of the bearing bar. In another aspect, an exemplary embodiment of the present disclosure may provide where the first offset is equal to the second offset. In another aspect, an exemplary embodiment of the present disclosure may provide where the first offset differs from the second offset. In another aspect, an exemplary embodiment of the present disclosure may provide where one or more additional slots defined in the bearing bar and where the one or more additional slots are located at one or more additional offsets from the top of the bearing bar. In another aspect, an exemplary embodiment of the present disclosure may provide where the one or more additional offsets are equal to one another and to the first offset and the second offset. In another aspect, an exemplary embodiment of the present disclosure may provide where the one or more additional offsets differ from one another. In another aspect, an exemplary embodiment of the present disclosure may provide where the one or more additional offsets differ from one or both of the first offset and the second offset. In another aspect, an exemplary embodiment of the present disclosure may provide where the second transverse bar is located closer to a midline of the bearing bar than the first transverse bar. In another aspect, an exemplary embodiment of the present disclosure may provide a bar assembly comprising the plurality of bearing bars and the plurality of transverse bars, a frame engaged with the plurality of bearing bars and the plurality of transverse bars, and where the bar assembly has a first side and a second side and a midline located equidistant from the first side and the second side and wherein the bar assembly is symmetrical about the midline. In another aspect, an exemplary embodiment of the present disclosure may provide a bar assembly comprising the plurality of bearing bars and the plurality of transverse bars, a frame engaged with the plurality of bearing bars and the plurality of transverse bars, and where the bar assembly has a first side and a second side and a midline located equidistant from the first side and the second side and wherein a transverse bar of the plurality of transverse bar located along the midline is of a greater height than another transverse bar of the plurality of transverse bar proximate the first side or the second side. In another aspect, an exemplary embodiment of the present disclosure may provide where each slot of the plurality of slots has a width; wherein each transverse bar of the plurality of transverse bars has a thickness; and wherein the widths of the plurality of slots are complementary to the thickness of the plurality of transverse bars. In another aspect, an exemplary embodiment of the present disclosure may provide where each slot of the plurality of slots has a height; wherein each transverse bar of the plurality of transverse bars has a height; and wherein the heights of the plurality of slots are complementary to the heights of the plurality of transverse bars.

In one aspect, an exemplary embodiment of the present disclosure may provide a method of forming a grating comprising providing a plurality of bearing bars, providing a plurality of transverse bars with different dimensions from one another, determining a weak point of the grating along a span of the grating, engaging a transverse bar with a largest dimension of the plurality of transverse bars with each of the plurality of bearing bars at the weak point of the grating, and engaging each transverse bar with a smaller dimension of the plurality of transverse with each of the plurality of bearing bars.

In another aspect, an exemplary embodiment of the present disclosure may provide determining a second weak point of the grating along the span of the grating and engaging a transverse bar with a second largest dimension of the plurality of transverse bars with each of the plurality of bearing bars at the second week point of the grating. In another aspect, an exemplary embodiment of the present disclosure may provide determining one or more additional weak points of the grating along the span of the grating and engaging a transverse bar with one or more dimensions which are smaller than the largest dimension and smaller than the second largest dimension with each of the plurality of bearing bars at the one or more additional weak points. In another aspect, an exemplary embodiment of the present disclosure may provide defining a plurality of slots in each bearing bar of the plurality of bearing bars, forming the plurality of slots with different dimensions from one another which are complementary to the different dimension of plurality of transverse bars, and inserting each transverse bar into a complementary slot of the plurality of slots. In another aspect, an exemplary embodiment of the present disclosure may provide where inserting each transverse bar is preceded by: arranging the plurality of bearing bars in parallel with one another and aligning the plurality of slots in the plurality of bearing bars with one another. In another aspect, an exemplary embodiment of the present disclosure may provide where forming the plurality of slots with different dimensions comprises forming the plurality of slots with different heights as measured from a top to a bottom of the plurality of slots. In another aspect, an exemplary embodiment of the present disclosure may provide where forming the plurality of slots with different dimensions comprises defining an offset for each of the plurality of slots where the offset is measured from a top of the plurality of bearing bar. In another aspect, an exemplary embodiment of the present disclosure may provide where providing the plurality of transverse bars with different dimensions comprising providing the plurality of transverse bars with different heights as measured from a top to a bottom of the plurality transverse bars. In another aspect, an exemplary embodiment of the present disclosure may provide where inserting each transverse bar of the plurality of transverse bars into a complementary slot of the plurality of slots comprises inserting a transverse bar of the plurality of transverse bars with a greatest height into a slot of the plurality of slots with a greatest height located along a midline of the plurality of bearing bars. In another aspect, an exemplary embodiment of the present disclosure may provide forming at least a first slot of the plurality of slots with a first dimension, forming at least a second slot of the plurality of slots with a different second dimension, forming at least a first transverse bar of the plurality of transverse bars with a complementary dimension to the first dimension, and forming at least a second transverse bar of the plurality of transverse bars with a complementary dimension to the second dimension. In another aspect, an exemplary embodiment of the present disclosure may provide forming one or more additional slots of the plurality of slots with one or more additional dimensions and forming one or more additional transverse bars of the plurality of transverse bars each with a complementary dimension to the one or more additional dimensions. In another aspect, an exemplary embodiment of the present disclosure may provide locating the first slot of the plurality of slots proximate a left side or a right side of each of the plurality of bearing bars, locating the second slot of the plurality of slots between the first slot and a midline of the plurality of bearing bars, and locating the one or more additional slots along the midline of the plurality of bearing bars. In another aspect, an exemplary embodiment of the present disclosure may provide forming at least a third slot of the plurality of slots with a third dimension, where the third dimension is larger than the first dimension and the second dimension and the second dimension is larger than the first dimension and forming at least a third transverse bar of the plurality of transverse bars with a complementary dimension to the third dimension. In another aspect, an exemplary embodiment of the present disclosure may provide where forming at least a first slot of the plurality of slots with a first dimension comprises defining a first offset for the first slot where the first offset is measured from a top of the plurality of bearing bar. In another aspect, an exemplary embodiment of the present disclosure may provide where forming at least a second slot of the plurality of slots with a different second dimension comprises defining a second offset for the second slot where the second offset is measured from the top of the plurality of bearing bar. In another aspect, an exemplary embodiment of the present disclosure may provide where forming at least a third slot of the plurality of slots with a different third dimension comprises defining a third offset for the third slot where the third offset is measured from the top of the plurality of bearing bar. In another aspect, an exemplary embodiment of the present disclosure may provide locating the first slot of the plurality of slots proximate a left side or a right side of each of the plurality of bearing bars and locating the second slot of the plurality of slots between the first slot and a midline of the plurality of bearing bars. In another aspect, an exemplary embodiment of the present disclosure may provide inserting the first transverse bar of the plurality of transverse bars into the first slot with the first dimension of the plurality of slots, inserting the second transverse bar of the plurality of transverse bars into the second slot with the second dimension of the plurality of slots, and where the second dimension is larger than the first dimension. In another aspect, an exemplary embodiment of the present disclosure may provide locating the third slot along the midline of the plurality of bearing bars. In another aspect, an exemplary embodiment of the present disclosure may provide inserting the third transverse bar of the plurality of transverse bars into the third slot with the third dimension of the plurality of slots and where the third dimension is larger than the first dimension and the second dimension.

### BRIEF DESCRIPTION OF THE DRAWINGS

One or more exemplary embodiment(s) of the present disclosure is set forth in the following description, is shown in the drawings and is particularly and distinctly pointed out and set forth in the appended claims. The accompanying drawings, which are incorporated in and constitute a part of the specification, illustrate various example configurations and methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a front, left, top perspective view of a grating in accordance with the present disclosure installed within a surface such as a sidewalk or road, wherein the grating includes a bar assembly in accordance with the present disclosure.

FIG. 2 is a front, left, top perspective view of the grating shown in isolation, wherein the bar assembly of the grating comprises a plurality of bearing bars and a plurality of transverse bars engaged with one another.

FIG. 3 is an exploded front, left, top perspective view of a portion of the grating shown in FIG. 2, showing a first embodiment of the plurality of bearing bars and showing the plurality of transverse bars in a first arrangement.

FIG. 4 is a front elevation view of a bearing bar of the grating of FIG. 3.

FIG. 4A is an enlarged front elevation view of a highlighted portion of the bearing bar shown in

FIG. 5A is a front, left, top perspective view of a portion of a first transverse bar of the first arrangement of the plurality of transverse bars.

FIG. 5B is a front, left, top perspective view of a portion of a second transverse bar of the first arrangement of the plurality of transverse bars.

FIG. 5C is a front, left, top perspective view of a portion of a third transverse bar of the first arrangement of the plurality of transverse bars.

FIG. 6 is an enlarged front elevation view of a portion of a bearing bar of the plurality of bearing bars with the first arrangement of the plurality of transverse bars engaged therewith.

FIG. 7 is a front elevation view of a second embodiment of a bearing bar for use in the grating in accordance with the present disclosure, with the plurality of transverse bars shown engaged with the second embodiment bearing bar in a second arrangement.

FIG. 8A is a front, left, top perspective view of a portion of a first transverse bar of the second arrangement of the plurality of transverse bars.

FIG. 8B is a front, left, top perspective view of a portion of a second transverse bar of the second arrangement of the plurality of transverse bars.

FIG. 8C is a front, left, top perspective view of a portion of a third transverse bar of the second arrangement of the plurality of transverse bars.

FIG. 9 is an enlarged front elevation view of a highlighted portion of the second embodiment bearing bar shown in FIG. 7.

FIG. 10 is a front elevation view of a third embodiment of a bearing bar for use in the grating in accordance with the present disclosure, with the plurality of transverse bars shown engaged with the third embodiment bearing bar in a third arrangement.

FIG. 11A is a front, left, top perspective view of a portion of a first transverse bar of the third arrangement of the plurality of transverse bars.

FIG. 11B is a front, left, top perspective view of a portion of a second transverse bar of the third arrangement of the plurality of transverse bars.

FIG. 11C is a front, left, top perspective view of a portion of a third transverse bar of the third arrangement of the plurality of transverse bars.

FIG. 12 is an enlarged front elevation view of a highlighted portion of the third embodiment bearing bar shown in FIG. 10.

FIG. 13 is a front elevation view of a fourth embodiment of a bearing bar for use in the grating in accordance with the present disclosure, with the plurality of transverse bars shown engaged with the fourth embodiment bearing bar in a fourth arrangement.

Similar numbers refer to similar parts throughout the drawings.

### DETAILED DESCRIPTION

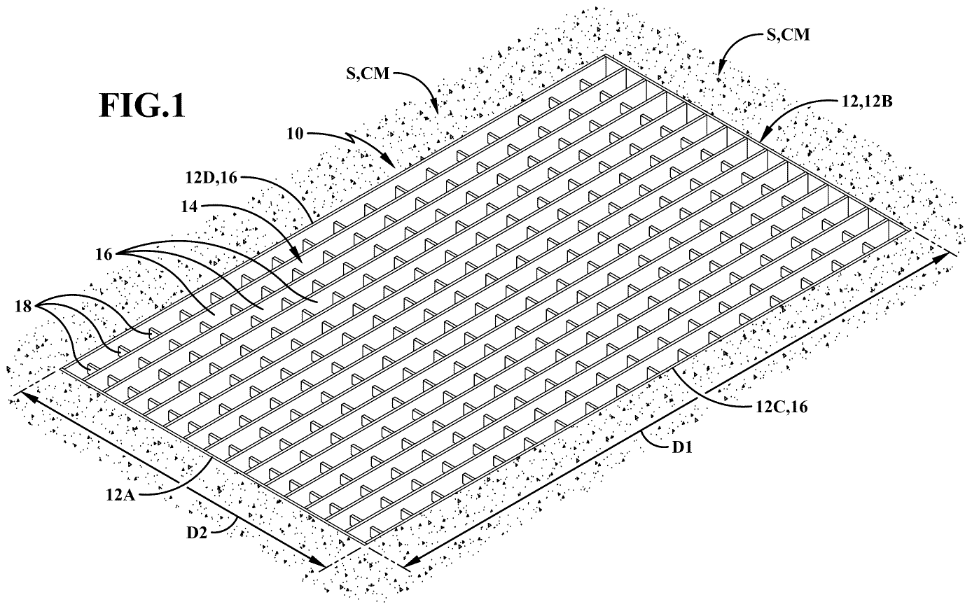

FIG. 1 shows a sidewalk (or road) “S” into which a grating 10 in accordance with the present disclosure has been installed. In accordance with the present disclosure the grating 10 comprises a frame 12 and a bar assembly 14. The bar assembly 14 is installed within the frame 12 and will be discussed in detail later herein.

The frame 12 includes a first frame member 12A, a second frame member 12B, a third frame member 12C, and a fourth frame member 12D. First frame member 12A and second frame member 12B are opposed to one another and are arranged parallel to one another. First and second frame member 12A, 12B are spaced a longitudinal first distance “D1” apart from one another. Third frame member 12C and fourth frame member 12D are opposed to one another and are arranged parallel to one another. Third and fourth frame members 120, 12D are spaced a lateral second distance “D2” apart from one another. Each of the first, second, third, and fourth frame members 12A, 12B, 12C, 12D comprises a rolled metal component which is welded or otherwise secured at each end to an end of an adjacent frame member to form an integral component. The configuration of each frame member 12A, 12B, 12C, 12D may vary depending on the particular application and location of grating 10.

It will be understood that the overall heights, length and width of first, second, third, and fourth frame members 12A, 12B, 12C, 12D will vary based on the desired overall size of grating 10. In the embodiment illustrated in FIG. 1, first and second frame members 12A, 12B will be of the same height, length and width as one another and third and fourth frame members 12C, 12D will be of the same height, length and width as one another.

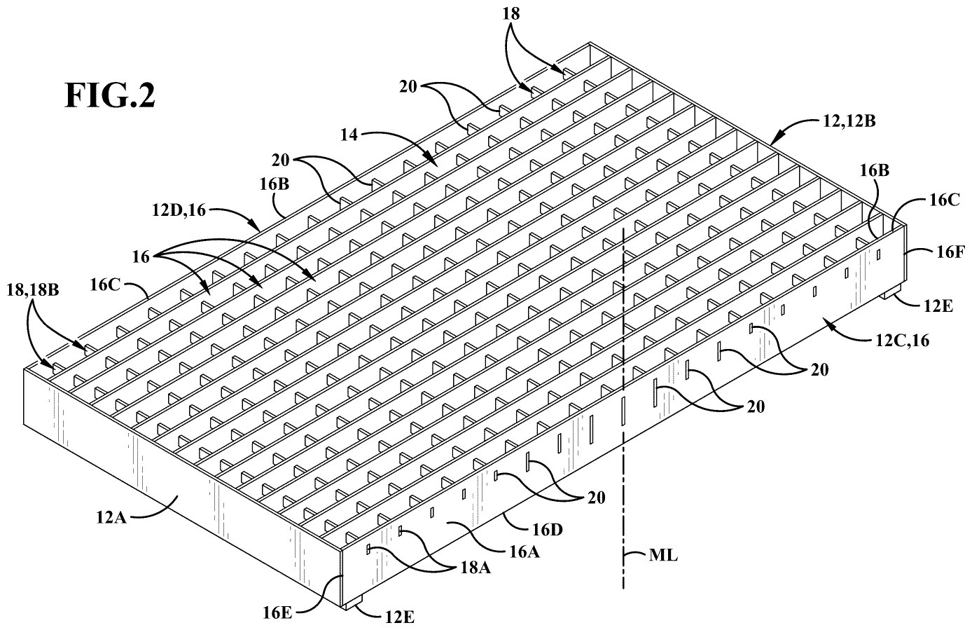

Grating 10 as illustrated in FIG. 1 is generally rectangular in shape but it will be understood that in other embodiments, grating 10 may, alternatively be square in shape or of any other desired shape. The frame 12 of grating 10 is permanently installed into sidewalk or road “S” with a compound material “CM”. The compound material “CM” may be any suitable material used to construct sidewalk or road “S”. Suitable materials for use as the compound material “CM” include concrete and asphalt. It should be understood, however, that any compound material, which dries and hardens, may be used instead of concrete or asphalt. The compound material “CM” may be any concrete or similar material that can achieve the strength necessary for vehicles and/or pedestrians to move across the installed grating 10. Additionally, while grating 10 depicted herein is illustrated as installed within sidewalk or road “S”, the grating 10 may be utilized in any application where there is need for a grating to be permanently installed within a compound material. Grating 10 defines a midline “ML” (FIG. 2) located between the bearing bar 16 first frame member 12A and second frame member 12B. Midline “ML” is equidistant from a first side and a second side of the bearing bar 16. Grating 10, as illustrated in FIG. 2, is symmetrical about the midline “ML”.

Referring to FIGS. 1-3, bar assembly 14 comprises a plurality of bearing bars 16 and a plurality of transverse bars 18 engaged with the bearing bars 16. Bearing bars 16 are arranged parallel to one another and are laterally spaced apart from one another. Bearing bars 16 are arranged orthogonal to first and second frame members 12A, 12B, i.e., at ninety degrees relative thereto. Transverse bars 18 are arranged orthogonal to bearing bars 16. Transverse bars 18 are arranged parallel to one another and are longitudinally spaced apart from one another. Bearing bars 16 and transverse bars 18, when engaged with one another, form a grid pattern. Because of the lateral spacing between adjacent bearing bars 16 and the longitudinal spacing between adjacent transverse bars 18, bar assembly 14 defines a plurality of apertures (not numbered) therein.

As discussed above, in grating 10, bearing bars 16 extend between first and second frame members 12A, 12B and transverse bars 18 extends between third and fourth frame members 120, 12D. The ends of bearing bars 16 may be welded or otherwise secured to first and second frame members 12A, 12B while the ends of transverse bars 18 may be welded or otherwise secured to third and fourth frame members 12C, 12D.

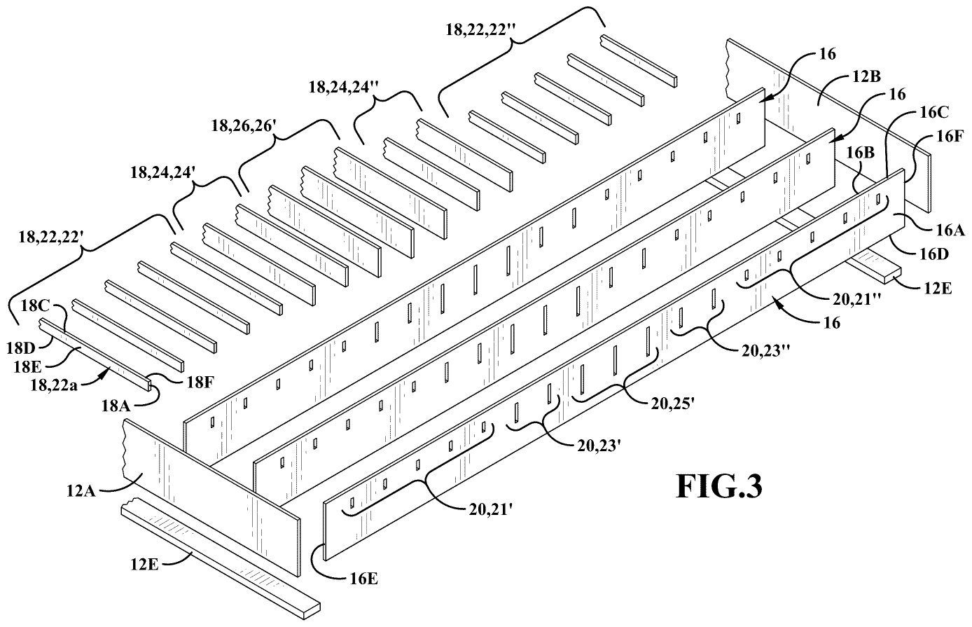

In one specific embodiment, one of the plurality of bearing bars 16 may serve as either of the third or fourth frame members 120, 12D and ends of transverse bars 18 may be welded or otherwise secured to these particular bearing bars 16. FIG. 2 illustrates this specific embodiment in that a first bearing bar 16 is utilized as the third frame member 12C and a second bearing bar 16 is utilized as the fourth frame member 12D. First frame member 12A and second frame member 12B are separate plates which extend between the ends of third frame member 12C and fourth frame member 12D. As shown in FIG. 3, additional frame members 12E may be utilized in frame 12.

Similarly, in another specific embodiment which is not illustrated herein, one of the plurality of transverse bars 18 may serve as either of the first or second frame members 12A, 12B and ends of the plurality of bearing bars 16 may be welded or otherwise secured to these particular transverse bars 18.

Referring to FIGS. 3, 4 and 5, the plurality of bearing bars 16 utilized in grating 10 will now be described in greater detail. As illustrated in the attached drawings, the bearing bars 16 utilized in grating 10 are rectangular prisms in configuration and may be made of suitable materials such as aluminum, carbon steel, etc. It will be understood, however, that any other type of configuration of bearing bar 16 may be utilized in bar assembly 14.

It will be understood that grating 10 may include any number of bearing bars 16 and transverse bars 18, depending on the size of grating 10. It will further be understood that each bearing bar 16 of the plurality of bearing bars 16 in grating 10 is substantially identical in structure and function. Consequently, the following description of bearing bar 16 applies equally to all of respective bearing bars 16 utilized in grating 10.

A first embodiment of bearing bar is illustrated in FIGS. 2-6. As best seen in FIGS. 2 to 4A, the first embodiment bearing bar 16 has a front surface 16A and a back surface 16B opposite one another. The distance between front surface 16A and back surface 16B comprises a thickness of the bearing bar 16.

In one embodiment, the thickness of bearing bar is between 0.05-0.3 inches. More specifically, the thickness is between 0.1-0.2 inches. Most specifically, the thickness of bearing bar 16 is about 0.188 inches.

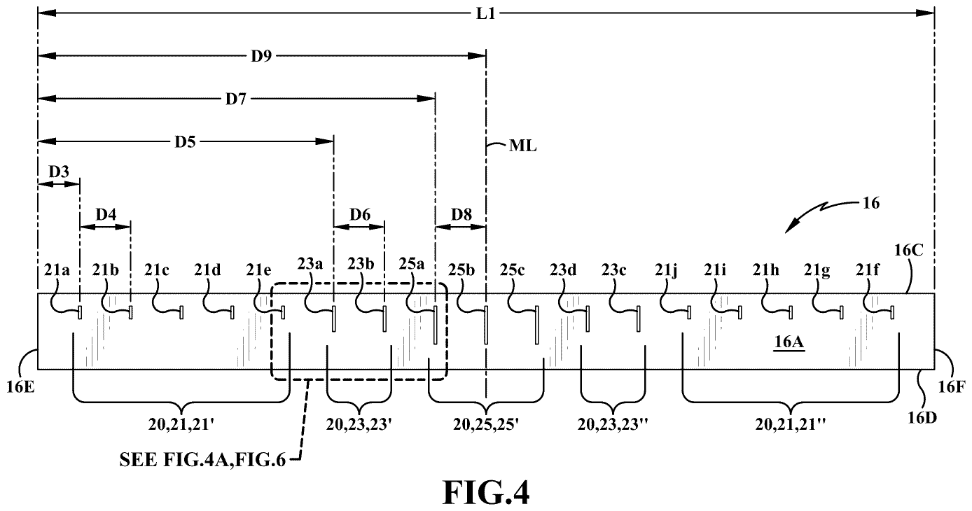

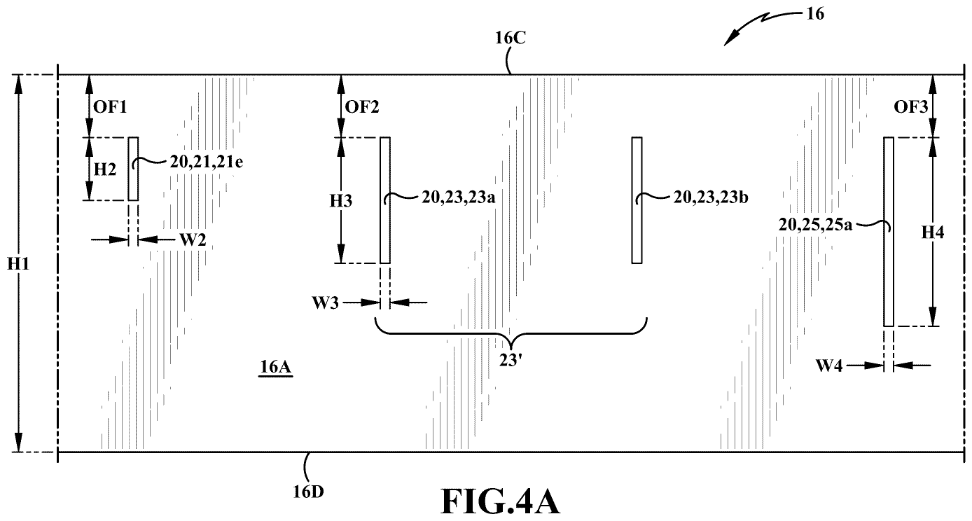

Bearing bar 16 further includes a top 16C and a bottom 16D opposite and spaced vertically apart from one another, and defining an uppermost and a lowermost limit of bearing bar 16, respectively. The distance between the top 16C and the bottom 16D defines a first height “H1” (FIG. 4A) of the bearing bar 16.

In one embodiment, first height “H1” is between 5.5-6.5 inches. More specifically, first height “H1” is between 5.25-6.25 inches. Most specifically, first height “H1” is about 6 inches.

Bearing bar 16 further includes a left side 16E and a right side 16F, opposed and spaced longitudinally apart from one another. The distance between the left side 16E and the right side 16F defines a first length “L1” (FIG. 4). The overall span (or length of the grating 10 is the first length “L1” plus the thicknesses of the first frame member 12A and second frame member 12B.

In one embodiment, first length “L1” is between 30-110 inches. More specifically, first length “L1” is between 50-90 inches. Most specifically, first length “L1” is about 70.625 inches.

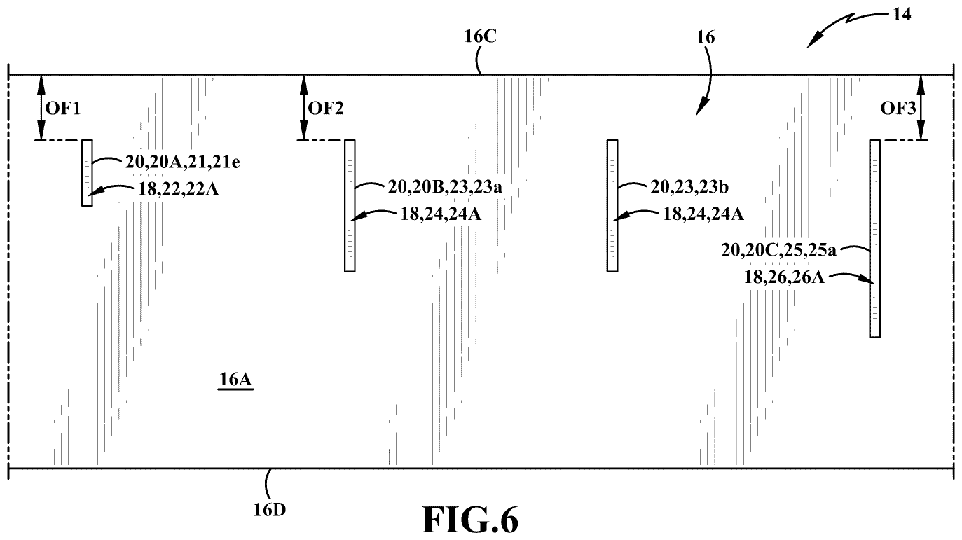

Referring to FIGS. 2 to 6, the first embodiment bearing bar 16 defines a plurality of slots 20 therein which extend from front surface 16A to back surface 16B of the bearing bar 16. As best seen in FIG. 6, each one of the plurality of slots 20 is of a size and shape configured to be complementary to a respective one of the plurality of transverse bars 18 utilized in bar assembly 14 (as will be later described herein). Bearing bar 16 defines a plurality of a first slot 21, a plurality of a second slot 23, and a plurality of a third slot 25. The first slots 21 are configured to be complementary to a configuration of a first transverse bar 22 (FIG. 3) of the plurality of transverse bars 18. The second slots 23 are configured to be complementary to a configuration of a second transverse bar 24 (FIG. 3) of the plurality of transverse bars 18. The third slots 25 are configured to be complementary to a configuration of a third transverse bars 24 (FIG. 3) of the plurality of transverse bars 18.

Each of the plurality of transverse bars 18 have a dimension which may be the length, width or thickness of each of the plurality of transverse bars 18.

As illustrated in FIG. 4, in the first embodiment bearing bar 16, there are two sets 21′, 21″ of first slots 21, two sets 23′, 23″ of second slots 23, and one set 25′ of third slots 25. There are five first slots 21a, 21b, 21c, 21d, and 21e in the first set 21′ of first slots 21. There are five first slots 21f, 21g, 21h, 21i, and 21j in the second set 21″ of first slots 21. There are two slots 23a, 23b in the first set 23′ of second slots 23. There are two slots 23c, 23d in the second set 23″ of second slots 23. There are three slots 25a, 25b, and 25c in the single set 25′ of third slots 25. The set 25′ of third slots is located centrally on bearing bar 16 with the midline ‘ML’ passing through the center of third slot 25b and the third slots 25a, 25c being spaced an equal distance outwardly away from third slot 25b. The sets 23′, 23″ of second slots 23 flank the single set 25′ of third slots 25. The first set 21′ of first slots 21 is located between left side 16E of bearing bar 16 and the first set 23′ of second slots 23. The second set 21″ of first slots 21 is located between right side 16F of bearing bar 16 and the second set 23″ of second slots 23.

Referring to FIG. 4, first slot 21 of the plurality of first slots 21 is spaced a third distance “D3” away from the left side 16E of bearing bar 16, where the third distance “D3” is measured from left side 16E of bearing bar 16 to a center of first slot 21a. Each of the first slots 21a through 21e are spaced a fourth distance “D4” apart from one another, where the fourth distance “D4” is measured from the center of on first slot 21 to a center of the adjacent first slot 21. For example, first slot 21c is spaced a fourth distance “D4” from first slot 21b and is furthermore spaced the fourth distance from first slot 21d. In one embodiment, “D4” is greater than “D3”. The second set 21″ of first slots 21 is arranged in a substantially identical manner relative to right side 16F of bearing bar 16 and relative to one another.

In one embodiment, third distance “D3” is between 1.5-5.5 inches. More specifically, third distance “D3” is between 2.5-4.5 inches Most specifically, third distance “D3” is about 3.5 inches. In one embodiment, fourth distance “D4” is between 1.5-5.5 inches. More specifically, fourth distance “D4” is between 2.5-4.5 inches. Most specifically, fourth distance “D4” is about 3.5.

It will be understood that although bearing bar 16 as illustrated herein includes five first slots in each set 21′, 21″ of first slots 21, in other embodiments fewer than five first slots or more than five first slots may be provided in each set 21′, 21″ of first slots 21.

Referring still to FIG. 4, second slot 23a of first set 23′ of second slots 23 is located a fifth distance “D5” from left side 16E of bearing bar 16, where the fifth distance “D5” is measured from left side 16E to the center of second slot 23a. Similarly, second slot 23c of second set 23″ of second slots 23 is located a fifth distance “D5” from right side 16F of bearing bar, where the fifth distance “D6” is measured from the right side to the center of second slot 23c. Second slot 23a and second slot 23b are located a sixth distance “D6” from one another, where the sixth distance “D6” is measured from the center of second slot 23a to the center of second slot 23b. Similarly, second slot 23c and second slot 23d are located a sixth distance “D6” from one another.

In one embodiment, the fifth distance “D5” is between 10-35 inches. More specifically, fifth distance “D5” is between 15-25 inches. Most specifically, fifth distance “D5” is about 23 inches. In one embodiment, the sixth distance “D6” is between 1.5-5.5 inches. More specifically, sixth distance “D6” is between 2.5-4.5 inches. Most specifically, sixth distance “D6” is about 3.5 inches.

It will be understood that although bearing bar 16 as illustrated herein includes two second slots 23 in each of the first set 23′ and the second set 23″, bearing bar 16 may alternatively have any number of second slots 23 defined in each of the first set 23′ and the second set 23″.

With continued reference to FIG. 4, third slot 25a of the single set 25′ of third slots 25 is located a seventh distance “D7” away from left side 16E of bearing bar 16, with the seventh distance “D7” being measured from the left side 16E to the center of third slot 25a. Similarly, third slot 25c is located the seventh distance “D7” away from right side 16F of bearing bar 16, with the seventh distance “D7” being measured from the left side 16F to the center of the third slot 25c. The third slots 25a, 25b, 25c are spaced at regular intervals of an eight distance “D8” from one another. The third slot 25b is located a ninth distance “D9” away from the left side 16E of the bearing bar 16, with the ninth distance being measured from the left side 16E to the center of third slot 25b.

In one embodiment, seventh distance “D7” is between 20-40 inches. More specifically, seventh distance “D7” is between 25-35 inches. Most specifically, seventh distance “D7” is about 31 inches. In one embodiment, eighth distance “D8” is between 1.5-5.5 inches. More specifically, eighth distance “D8” is between 2.5-4.5 inches. Most specifically, eighth distance “D8” is about 3.5 inches. In one specific embodiment, the distance between the left side 18E of the bearing bar 16 and the midline “ML” of grating 10 is equal to the ninth distance “D9”.

FIG. 4A shows that first slots 21 are of a second height “H2” and second width “W2”, second slots 23 are of a third height “H3” and third width “W3”, and third slots 25 are of a fourth height “H4” and fourth width “W4”.

In one embodiment, second height “H2” is between 0.5-1.5 inches. More specifically, second height “H2” is between 0.75-1.25 inches. Most specifically, second height “H2” is about 1 inch. In one embodiment, second width “W2” is between 0.05-0.2 inches. More specifically, second width “W2” is between 0.1-0.15 inches. Most specifically, second width “W2” is about 0.125 inches.

In one embodiment, third height “H3” is between 1.5-2.5 inches. More specifically, third height “H3” is between 1.75-2.25 inches. Most specifically, third height “H3” is about 2 inches. In one embodiment, third width “W3” is between 0.05-0.2 inches. More specifically, third width “W3” is between 0.1-0.15 inches. Most specifically, third width “W3” is about 0.125 inches.

In one embodiment, fourth height “H4” is between 2.5-3.5 inches. More specifically, fourth height “H4” is between 2.75-3.25 inches. Most specifically, fourth height “H4” is about 3. In one embodiment, fourth width “W4” is between 0.05-0.2 inches. More specifically, fourth width “W4” is between 0.1-0.15 inches. Most specifically, fourth width “W4” is about 0.125 inches.

As best seen in FIG. 4A, each of the plurality of slots 20 is offset from the top 16C of the associated bearing bar 16. The offset comprises a set depth relative to the top 16C of bearing bars 16. A top end of each of the first slots 21 is at a first offset “OF1” relative to top 16C. A top end of each of the second slots 23 is at a second offset “OF2” relative to the top 16C. A top end of each of the third slots 25 is at a third offset “OF3” relative to the top 16C. In the first embodiment bearing bar 16, first offset “OF1”, second offset “OF2” and third offset “OF3” are all substantially equal to one another. It will be understood, however, that in other embodiments, one or more of the first offset “OF1”, second offset “OF2” and third offset “OF3” may be different from one another. Now that the bearing bars 16 of bar assembly 14 have been described in detail, the transverse bars 18 of bar assembly will be discussed. As illustrated in the attached drawings, each of the transverse bars 18 utilized in grating 10 is a rectangular prism in configuration and may be made of suitable materials such as aluminum, carbon steel, etc. It will be understood, however, that any other type of configuration of transverse bar 18 may be utilized in bar assembly 14.

As best seen in FIGS. 2 and 3, each one of the plurality of transverse bars 18 has a front 18A and a back 18B arranged opposite one another and a spaced length apart from one another. Each one of the plurality of transverse bars 18 further includes a top 18C and a bottom 18D arranged opposite one another and defining an uppermost and a lowermost limit the transverse bar 18, respectively. The height of the transverse bar 18 is measured between top 18C and bottom 18D. Each one of the plurality of transverse bars 18 further includes a left side 18E and a right side 18F, where the distance between the left side 18E and the right side 18F define the overall width or thickness of the transverse bar 18.

FIGS. 3-6 show grating 10 with the plurality of transverse bars 18 in a first arrangement and positioned for engagement with first embodiment bearing bars 16. As best seen in FIGS. 3 and 4, the plurality of transverse bars 18 of the bar assembly 14 comprises three different types of transverse bars, namely, a first transverse bar 22, a second transverse bar 24 and a third transverse bar 26. In particular, the illustrated bar assembly 14 includes a first set 22′ of the first transverse bar 22 located proximate to the left side 16E of the bearing bars 16 and a second set 22″ of the first transverse bars 22 located proximate to the right side 16F of the bearing bar 16. Bar assembly 14 further includes a first set 24′ of the second transverse bar 24 located proximate to the first set 22′ of the first transverse bar 22 and a second set 24″ of the second transverse bar 24 located proximate to the second set 22″ of the first transverse bar 22. Bar assembly 14 further includes a single set 26′ of the third transverse bar 26 located between the first set 24′ and the second set 24″ of the second transverse bar 26.

As illustrated in FIGS. 3-6, each of the first set 22′ and the second set 22″ of the first transverse bars 22 includes five transverse bars 22. Each of the first set 24′ and the second set 24″ of the second transverse bars 24 comprises two transverse bars 24. The single set 26′ of third transverse bars 26 comprises three transverse bars 26. It will be understood that in other embodiments, the plurality of transverse bar 18 utilized in bar assembly 14 may be comprised of any desired number of first transverse bars 22, second transverse bars 24 and/or third transverse bars 26. It will further be understood that bar assembly 14 may comprise only two different types of transverse bar (such as first transverse bars 22 and third transverse bars 26) or may comprise more than three different types of transverse bar. The particular types of transverse bar utilized in the bar assembly 14 will be selected based on the particular application in which grating 10 is to be used.

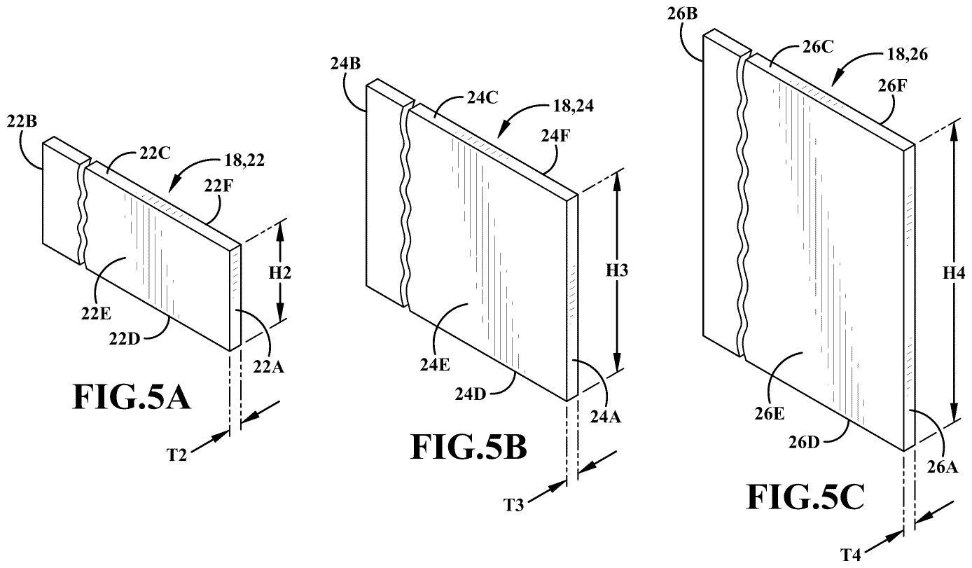

As best seen in FIGS. 3 and 5A, each first transverse bar 22 has a front 22A and a back 22B opposite one another. The first transverse bar 22 further includes a top 22C and a bottom 22D opposite and spaced a distance vertically apart from one another, where the space between the top 22C and the bottom 22D defines a second height “H2” of the first transverse bar 22. The second height “H2” is smaller than the first height “H1”. The first transverse bar 22 further includes a left side 22E and a right side 22F opposite and spaced apart one another, where the space between the left side 22E and the right side 22F defines a second thickness “T2” of the first transverse bar 22. First transverse bar 22 is configured to be receivably engaged in one of the first slots 21 defined in bearing bar 16. The height “H2” and thickness “T2” of first transverse bar 22 is marginally smaller than the height “H2” and width “W2” of the first slots 21 so that first transverse bar 22 is able to be inserted into one of the first slots 21 in bearing bar 16.

In one embodiment, second height “H2” is between 0.5-1.5 inches. More specifically, second height “H2” is between 0.75-1.25 inches. Most specifically, second height “H2” is about 1 inch. In one embodiment, second thickness “T2” is between 0.05-0.2 inches. More specifically, second thickness “T2” is between 0.1-0.15 inches. Most specifically, second thickness “T2” is about 0.125 inches.

When a first bar 22a (FIG. 3) of the first set 22′ of the first transverse bars 22 is received in the first slot 21a of bearing bar 16, the first bar 22a will be spaced a third distance “D3” away from the left side 16E of bearing bar 16. The first transverse bars 22 received in the other first slots 21 of the first set 21′ thereof will be spaced a fourth distance “D4” apart from one another. The second set 22″ of first transverse bars 22 is engaged in the second set 21″ of first slots 21 and will therefore be spaced and located in a substantially identical manner relative to the right side 16E of bearing bar 16.

In one embodiment, third distance “D3” is between 1.5-5.5 inches. More specifically, third distance “D3” is between 2.5-4.5 inches Most specifically, third distance “D3” is about 3.5 inches. In one embodiment, fourth distance “D4” is between 1.5-5.5 inches. More specifically, fourth distance “D4” is between 2.5-4.5 inches. Most specifically, fourth distance “D4” is about 3.5.

It will be understood that although bar assembly 14 as illustrated herein includes five first transverse bars 22 in each the first set 22′ and the second set 22″, bar assembly 14 may alternatively have any number of first transverse bars 22 in each of the first set 22′ and the second set 22″. The number of first slots 21 defined in bearing bar 16 and the number of first transverse bars 22 for engagement in the first slots 21 is complementary.

As best seen in FIGS. 3 and 5B, each second transverse bar 24 has a front 24A and a back 24B opposite one another. The second transverse bar 24 further includes a top 24C and a bottom 24D opposite and spaced a distance apart from one another, where the space between the top 24C and the bottom 24D defines a third height “H3” of the second transverse bar 24. The third height “H3” is greater than the second height “H2”. The second transverse bar 24 further includes a left side 24E and a right side 24F opposite and spaced apart one another, where the space between the left side 24E and the right side 24F defines a third thickness “T3” of the second transverse bar 24. The third thickness “T3” may be equal to the second thickness “T2” or may be greater or smaller than second thickness “T2”.

In one embodiment, the third height “H3” is between 1.5-2.5 inches. More specifically, third height “H3” is between 1.75-2.25 inches. Most specifically, third height “H3” is about 2 inches. In one embodiment, the third thickness “T3” is between 0.05-0.2 inches. More specifically, third thickness “T3” is between 0.1-0.15 inches. Most specifically, third thickness “T3” is about 0.125 inches.

A first bar 24a of the first set 24′ of the second transverse bars 24 is received in the second slot 23a of the first set 23′ of slots 20 defined in bearing bar 16. It will be understood that the third height “H3” and third thickness “T3” of the second transverse bars 24 is marginally smaller than the third height “H3” and third width “W3” of the second slots 23 so that the second transverse bars 24 are able to be inserted into the associated second slots 23. When first bar 24a is inserted into second slots 23a, first bar 24a is spaced apart from left side 16E of bearing bar 16 a fifth distance “D5” measured from left side 18E of bearing bar 16 to a center of first bar 24a. Each of the second transverse bars 24 is received in one of the second slots 23 of the bearing bar 16 The second transverse bars 24 of the first set 24′ are spaced a sixth distance “D6” apart from one another as measured between the centers of the two second transverse bars. The second set 24″ of the second transverse bars 24 is spaced and located relative to the right side 16E of bearing bar 16 in a substantially identical manner.

In one embodiment, fifth distance “D5” is between 10-35 inches. More specifically, fifth distance “D5” is between 15-25 inches. Most specifically, fifth distance “D5” is about 23 inches. In one embodiment, sixth distance “D6” is between 1.5-5.5 inches. More specifically, sixth distance “D6” is between 2.5-4.5 inches. Most specifically, sixth distance “D6” is about 3.5 inches.

It will be understood that although bar assembly 14 as illustrated herein includes two second transverse bars 24 in each the first set 24′ and the second set 24″, bar assembly 14 may alternatively have any number of second transverse bars 24 in each of the first set 24′ and the second set 24″.

Referring now to FIGS. 4 and 5C, the bar assembly 14 further includes a single set 26′ of the third transverse bar 26 located between the first set 24′ and the second set 24″ of the second transverse bar 26.

As best seen in FIG. 5C, the third transverse bar 26 has a front 26A and a back 26B opposite one another. The third transverse bar 26 further includes a top 26C and a bottom 26D opposite and spaced a distance apart from one another, where the space between the top 26C and the bottom 26D defines a fourth height “H4” of the third transverse bar 26. The third transverse bar 26 further includes a left side 26E and a right side 26F opposite and spaced apart one another, where the space between the left side 26E and the right side 26F defines a fourth thickness “T4” of the third transverse bar 26.

In one embodiment, the fourth height “H4” is between 2.5-3.5 inches. More specifically, fourth height “H4” is between 2.75-3.25 inches. Most specifically, fourth height “H4” is about 3. In one embodiment, fourth thickness “T4” is between 0.05-0.2 inches. More specifically, fourth thickness “T4” is between 0.1-0.15 inches. Most specifically, fourth thickness “T4” is about 0.125 inches.

It will be understood that the fourth height “H4” and fourth thickness “T4” of the third transverse bars 26 is marginally smaller than the fourth height “H4” and fourth width “W4” of the third slots 25 defined in bearing bar 16. This enables the third transverse bars 26 to be inserted into the associated third slots 25 defined in bearing bar 16. When a first bar 26a of the set 26′ of third transverse bars 26 is received in the third slot 25a of bearing bar 16, first bar 26a is spaced apart from left side 18E of bearing bar 16 for a seventh distance “D7” measured from left side 18E of bearing bar 16 to a center of first bar 26a. Adjacent third transverse bars 26 are spaced an eighth “D8” apart from one another as measured between the centers of the third transverse bars 26. A middle or second bar 26b of the third transverse bars 26 is spaced apart from the left side 16E of bearing bar 16 for a ninth distance “D9” measured from left side 16E to a center of the middle bar or second bar 26b.

In one embodiment, seventh distance “D7” is between 20-40 inches. More specifically, seventh distance “D7” is between 25-35 inches. Most specifically, seventh distance “D7” is about 31 inches. In one embodiment, eighth distance “D8” is between 1.5-5.5 inches. More specifically, eighth distance “D8” is between 2.5-4.5 inches. Most specifically, eighth distance “D8” is about 3.5 inches. In one embodiment, ninth distance “D9” is between 15-55 inches. More specifically, ninth distance “D9” is between 25-45 inches. Most specifically, ninth distance “D9” is about 35 inches.

In one specific embodiment, the distance between the left side 18E of the bearing bar 16 and the midline “ML” of grating 10 is equal to the ninth distance “D9”.

It will be understood that although bar assembly 14 as illustrated herein includes three third transverse bars 26, bar assembly 14 may alternatively have any number of third transverse bars 26.

In one embodiment, it will be understood that the first transverse bar 22 is of a first height and the second transverse bar 24 is of a second height and the second height is larger than the first height. It will also be understood that the third transverse bar 26 is of a third height and the third height is larger than the first height and the second height.

It will be understood that the various measurements of the slots 20 of the bearing bars 16 and transverse bars 16 are exemplary in nature, but it should be understood that grating 10 and bar assembly 14 will include bearing bars 16 and transverse bars 18 that are sized and placed in a location relative to one another in a similar matter to the aforementioned measurements on a proportional basis.

Referring now to FIGS. 3 and 6, each of the plurality of bearing bars 16 is engaged with the plurality of transverse bars 18. Specifically, a portion of each transverse bar 18 is received within a complementary associated one of the plurality of slots 20 in the bearing bar 16.

As discussed earlier herein with reference to FIG. 6, the plurality of slots 20 are offset from the top 16C of the bearing bar 16. As a consequence, the transverse bars 18 when engaged with the bearing bars 16 are offset a depth relative to the top 16C of the associated bearing bar 16. The first slot 21 and thereby the first transverse bar 22 are located at a first offset “OF1” relative to the top 16C of the bearing bar 16. The second slot 20B and thereby the second transverse bar 24 are located at a second offset “OF2” relative to the top 16C of the bearing bar 16. The third slot 20C and thereby the third transverse bar 26 are located at a third offset “OF3” relative to the top 16C of the bearing bar 16.

It will be understood that although grating 10 as illustrated herein depicts first offset “OF1”, second offset “OF2” and third offset “OF3” equal to one another, alternatively, first offset “OF1”, second offset “OF2” and third offset “OF3” may be different from one another.

It will be understood that bar assembly 14 as illustrated herein includes first slot 21, first transverse bar 22, first offset “OF1”, second slot 23, second transverse bar 24, second offset “OF2”, third slot 25, third transverse bar 26, and third offset “OF3”, bar assembly 14 may alternatively include first slot 21, first transverse bar 24, second slot 23, second transverse bar 24, one or more additional slots, one or more additional transverse bars, and one or more additional offsets. It will be understood that bar assembly 14 may have any number of slots within the plurality of slots 20 and any number of transverse bars within the plurality of transverse bars 18 which are at any number of offsets from the top of the bearing bar.

The offset of the slots 20 and therefore of the associated plurality of transverse bars 18 depends on the size of each one of the plurality of bearing bars 16. The following chart depicts an exemplary standard and an exemplary maximum offset of each one of the slots 20 and plurality of transverse bars 18 depending on a height, such has the first height “H1” (FIG. 4), of each one of the plurality of bearing bars 16.

| Height of each one | Standard offset of each | Maximum offset of each |
|---|---|---|
| of the plurality of | one of the plurality of | one of the plurality of |
| bearing bars 16 | transverse bars 18 | transverse bars 18 |
| 3″ | 1″ | 1″ |
| 4″ | 1″ | 2″ |
| 5″ | 1″ | 3″ |
| 6″ | 1″ | 4″ |
| 7″ | 1″ | 5″ |
| 8″ | 1″ | 6″ |
| 9″ | 1″ | 7″ |

A stiffness and strength of the grating 10 is determined by the stiffness and strength of the bar assembly 14. The bearing bar 16 and the transverse bar 18 together determine the overall strength of bar assembly 14 and thereby grating 10. The stiffness of the bearing bar 16 and transverse bar 18 is governed by the shape of each of the bearing bar 16 and transverse bar 16. The stiffness of each is associated with the section modulus of the bar. The section modulus is calculated by the following equation

$$Ix ( Section Modulus ) = \frac{B ( b ase ) * H {( height )}^{3}}{12} ,$$

meaning an increase in height of the bar increases the section modulus and thereby the stiffness bar.

An increase in the section modulus of the transverse bar 18 will therefore increase the strength of the grating 10.

Having now described grating 10, a method of forming grating 10 will be discussed herein.

Grating 10 is formed by providing a plurality of bearing bars 16 and defining a plurality of slots 20 in each bearing bar 16 of the plurality of bearing bars 16. The plurality of slots 20 are formed with different dimensions from one another. The plurality of transverse bars 18 are provided with different dimensions from one another and the different dimensions of the plurality of transverse bars 18 are complementary to the different dimensions of the plurality of slots 20. Each transverse bar 18 of the plurality of transverse bars 18 are inserted into a complementary slot 20 of the plurality of slots 20. Before inserting each transverse bar 18 the plurality of bearing bars 16 are arranged in parallel with one another and the plurality of slots 20 in the plurality of bearing bars 16 are aligned with one another. Forming the plurality of slots 20 with different dimensions includes forming the plurality of slots 20 with different heights as measured from a top to a bottom of the plurality of slots 20. Inserting each transverse bar 18 of the plurality of transverse bars 18 into a complementary slot 20 of the plurality of slots 20 includes inserting a transverse bar 18 of the plurality of transverse bars 18 with the greatest height into a slot 20 of the plurality of slots 20 with a greatest height located along the midline of the plurality of bearing bars 16. The method further includes forming at least a first slot 21 of the plurality of slots 20 with a first dimension and forming at least a second slot 23 of the plurality of slots 20 with a different second dimension. The method further includes forming at least a first transverse bar 22 of the plurality of transverse bars 18 with a complementary dimension to the first dimension and forming at least a second transverse bar 24 of the plurality of transverse bars 18 with a complementary dimension to the second dimension.

In optimizing the strength of gratings 10, it is important to determine the shape and location each transverse bar 18 within bar assembly 14.

The plurality of transverse bars 18 which vary in height and are complementary to the plurality of slots 20 defined in the plurality of bearing bar 16 is beneficial because the varying heights of the plurality of transverse bars 18 allow for grating 10 to be a lighter overall weight than a grating with uniform transverse bars while maintaining the structural strength and the overall stiffness of the grating 10 compared to a grating with a larger transverse bar uniformly placed along the plurality of bearing bars 16. This is beneficial as it allows for grating 10 to be less expensive to manufacture, ship and install compared to a grating with the larger transverse bar uniformly placed along the plurality of bearing bars 16 while maintaining the structural integrity and stability of the overall grating 10.

It will be understood that although grating 10 as illustrated herein has the first, second and third slots 21, 22, 23 and the complementary first, second and third transverse bars 20, 22, 24, grating 10 may alternatively have any number of different slots and transverse bars.

It will also be understood that although grating 10 as illustrated herein has a first and set second of the first slot 21, the second slot 23, the first transverse bar 22, and the second transverse bar 24 and one set of the third slot 25 and the third transverse bar 24, grating 10 may alternatively have any number of sets any of the slots or transverse bars.

It will even further be understood that although grating 10 as illustrated herein has the smallest of the slots 20 and transverse bars 18 at ends of the bearing bars 16 and the largest of the slots 20 and transverse bars 18 being proximate the midline, grating 10 may alternatively have any arrangement of the slots 20 and transverse bars 18. For example, the largest can be interspersed along the plurality of bearing bars 16. Therefore, grating 10 may have any number of arrangements of the slots 20 and the transverse bars 18.

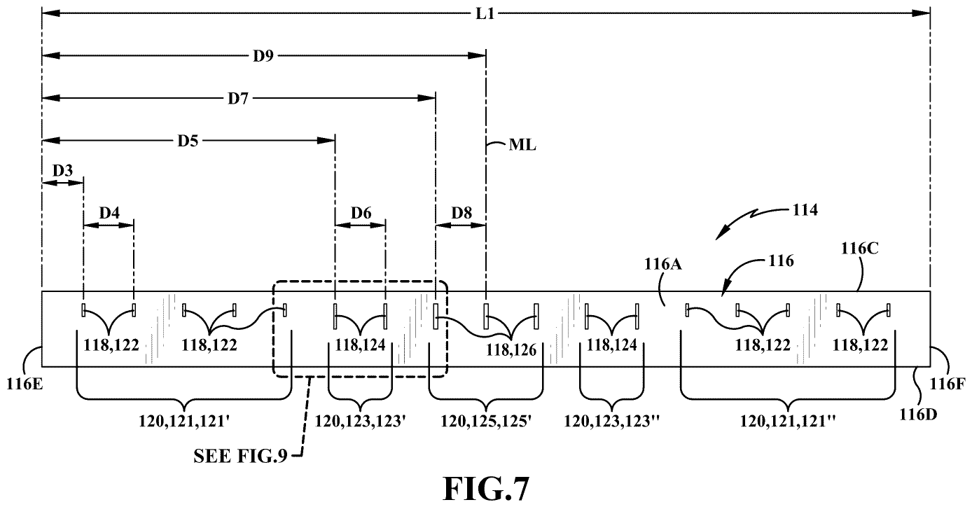

Referring now to FIGS. 7-9, there is shown a second embodiment of a bar assembly 114 in accordance with the present disclosure which may be utilized to produce a grating substantially similar to grating 10. Bar assembly 114 is substantially identical to bar assembly 14 for use in a grating in a similar manner to grating 10 except for the differences discussed hereafter. Bar assembly 114 comprises a plurality of bearing bars 116 and a plurality of transverse bars 118 engaged with one another in a manner substantially similar to the way in which bearing bars 16 engage transverse bars 18 to form bar assembly 14.

In accordance with an aspect of the present disclosure, bearing bar 116 is a second embodiment bearing bar which defines a plurality of slots 120 therein. The bearing bar 116 itself is substantially identical to bearing bar 16, having a front 116A, a back (not shown), a top 116C, a bottom 116D, a left side 116E and right side 116F. Bearing bar 116 differs from bearing bar 16 in the arrangement of the slots 120 defined therein.

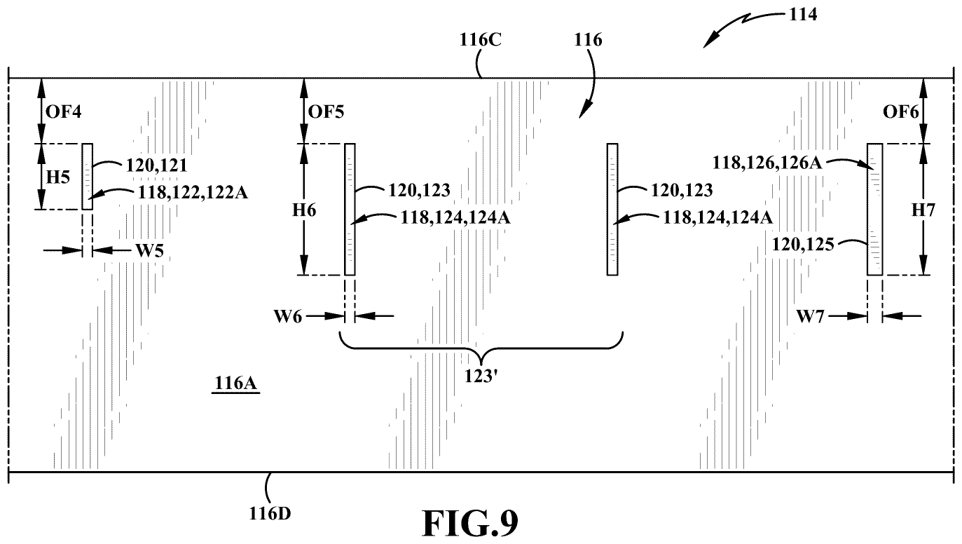

As best seen in FIGS. 7 and 9, bearing bar 116 defines a plurality of first slots 121, a plurality of second slots 123, and a plurality of third slots 125. The plurality of first slots 121 are arranged in a first set 121′ located proximate left side 116E of bearing bar 116 and a second set 121″ located proximate right side 116F of bearing bar 116. First and second sets set 121′, 121″ of first slots 121 are substantially identical in structure and function to first and second set 21′, 21″ of first slots 21 of bearing bar 16. As shown in FIG. 9, each first slot 121 is of a fifth height “H5”, of a fifth width “W5” and the top of the slot 121 is located at a fourth offset “OF4” from the top 116C of second embodiment bearing bar 116. In one embodiment, the fifth height “H5” on bearing bar 116 is substantially equal to the second height “H2” (FIG. 4A) on bearing bar 16, the fifth width “W5” on bearing bar 116 is substantially equal to the second width “W2” on bearing bar 16, and the fourth offset “OF4” on bearing bar 116 is substantially equal to the first offset “OF1” of bearing bar 16.

The plurality of second slots 123 defined in bearing bar 116 are arranged in a first set 123′ located proximate the first set 121′ of first slots 121 and a second set 123″ located proximate the second set 121″ of first slots 121. First and second sets 123′, 123″ of second slots 123 on bearing bar 116 are substantially identical in structure and function to first and second sets 23′, 23″ of second slots 23 of bearing bar 16. As shown in FIG. 9, each second slot 123 is of a sixth height “H6”, is of a sixth width “W6”, and is located at a fifth offset “OF5” from the top 116C on bearing bar 116. In one embodiment, the sixth height “H6” on bearing bar 116 is substantially equal to the third height “H3” (FIG. 4A) on bearing bar 16, the sixth width “W6” on bearing bar 116 is substantially equal to the third width “W3” on bearing bar 16, and the fifth offset “OF5” on bearing bar 116 is substantially equal to the second offset “OF2” on bearing bar 16.

The plurality of third slots 125 defined in bearing bar 116 are arranged in a first set 125′ located intermediate the first and second sets 123′, 123″ of second slots 123. This arrangement is similar to how the first set 25′ of third slots 25 are located intermediate first and second sets 23′, 23″ of second slots 23 in bearing bar 16. The top ends of third slots 125 are located a sixth offset “OF6” from top 116C of bearing bar 116 and the sixth offset “OF6” may be substantially equal to the third offset “OF3” (FIG. 4) of third slots 25 on bearing bar 16. Third slots 125 on bearing bar 116 differ from third slots 25 on bearing bar 16 in that the seventh height “H7” of each third slot 125 is smaller than the fourth height “H4 of third slots 25 on bearing bar 16. In one embodiment, the seventh height “H7” of third slots 125 may be the same as the sixth height “H6” of second slots 123 on bearing bar 116. Additionally or alternatively, the seventh width “W7” of third slots 125 is greater than the fourth width “W4” of third slots 25 on bearing bar 16. The seventh width “W7” is also greater than the fifth width “W5” of first slots 121 and is greater than the sixth width “W6” of second slots 123.

It will be understood that in other embodiments the third slots 125 may be of substantially the same dimensions as the third slots 25 of bearing bar 16 and one or both of the first slots 121 and second slots 123 may be longer or shorter in height than the heights “H5”, “H6” and/or may be wider or narrower in width than the widths “W5”, “W6”.

It should be noted that the second arrangement of slots 120 defined in bearing bar 116 places the various slots 120 at the same distances “D3” through “D9” as the slots 20 in bearing bar 16. In other embodiments, these distances “D3” through “D9” may differ from the distances illustrated in FIG. 7.

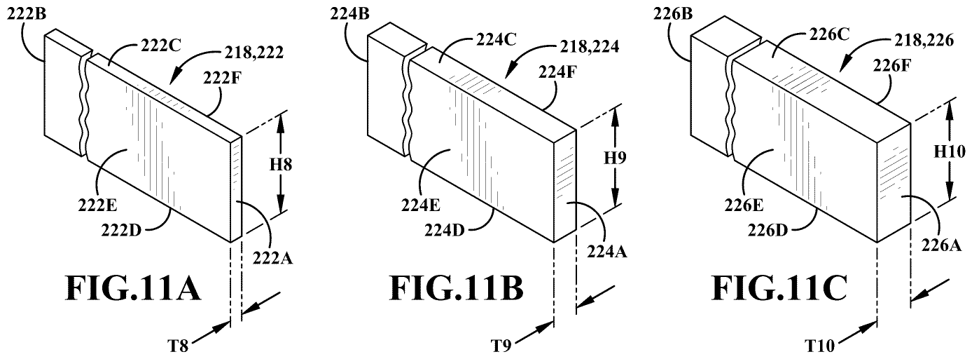

Bearing bar 116 is provided with a plurality of slots 120 that is complementary in configuration to a plurality of transverse bars 118 to be received therein. The plurality of transverse bars 118 are illustrated in FIGS. 11A, 11B, and 11c. The plurality of transverse bars 118 include a plurality of first transverse bars 122, a plurality of second transverse bar 124, and a plurality of third transverse bars 126. First transverse bars 122 are complementary to first slots 121, second transverse bars 124 are complementary to second slots 123, and third transverse bars 125 are complementary to third slots 125.

The plurality of transverse bars 118 configured to engage second embodiment bearing bar 116 is in a second arrangement which differs from the first arrangement in the configuration of some of the transverse bars 118, particularly those transverse bars configured to be received in the third slots 125 of bearing bar 116, It will be understood that the bar assembly 114 may include any desired number of first transverse bars 122, second transverse bars 124 and/or third transverse bars 126.

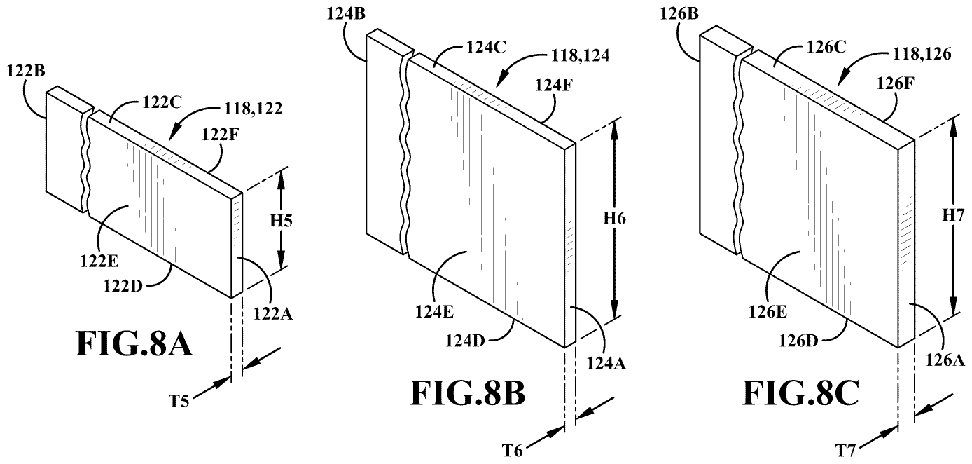

As best seen in FIG. 8A, the first transverse bar 122 has a front 122A and a back 122B opposite one another. The first transverse bar 122 further includes a top 122C and a bottom 122D opposite and spaced a distance apart from one another, where the space between the top 122C and the bottom 122D defines a fifth height “H5” of the first transverse bar 122. The first transverse bar 122 further includes a left side 122E and a right side 122F opposite and spaced apart one another, where the space between the left side 122E and the right side 122F defines a fifth thickness “T5” of the first transverse bar 122. First transverse bar 122 is sized so that height “H5” and thickness “T5” thereof are only marginally smaller than the fifth height “H5” and fifth width “W5” of the first slots 121 defined in bearing bar 116.

In one embodiment, fifth height “H5” is between 0.5-1.5 inches. More specifically, fifth height “H5” is between 0.75-1.25 inches. Most specifically, fifth height “H5” is about 1 inch. In one embodiment, fifth thickness “T5” is between 0.05-0.2 inches. More specifically, fifth thickness “T5” is between 0.1-0.15 inches. Most specifically, fifth thickness “T5” is about 0.125 inches.

It will be understood that although bar assembly 114 as illustrated herein includes five first transverse bars 122 to be engaged in each of the first set 121′ and the second set 121″ of first slots 121 of bearing bar 116, bar assembly 114 may alternatively have any number of first transverse bars 122 complementary to the number of first slots 121 in the first set 121′ and second set 121″ of first slots in bearing bar 116.

As best seen in FIG. 8B, the transverse bars 118 of bar assembly 114 includes a second transverse bar 124 having a front 124A and a back 124B located opposite one another. The second transverse bar 124 further includes a top 124C and a bottom 124D opposite and spaced a distance apart from one another, where the space between the top 124C and the bottom 124D defines a sixth height “H6” of the second transverse bar 124. The second transverse bar 124 further includes a left side 124E and a right side 124F opposite and spaced apart one another, where the space between the left side 124E and the right side 124F defines a sixth thickness “T6” of the second transverse bar 124. Second transverse bar 124 is sized so that height “H6” and thickness “T6” thereof are only marginally smaller than the sixth height “H6” and sixth width “W6” of the second slots 123 defined in bearing bar 116.

In one embodiment, sixth height “H6” is between 1.5-2.5 inches. More specifically, sixth height “H6” is between 1.75-2.25 inches. Most specifically, sixth height “H6” is about 2 inches. In one embodiment, sixth thickness “T6” is between 0.05-0.2 inches. More specifically, sixth thickness “T6” is between 0.1-0.15 inches. Most specifically, sixth thickness “T6” is about XXXX. In one embodiment, seventh height “H7” is between 0.125 inches.

It will be understood that although bar assembly 114 as illustrated herein includes two second transverse bars 124 engageable in each of the first set 123′ and the second set 123″ of second slots 123, bar assembly 114 may alternatively have any number of second transverse bars 124 to be engaged in a complementary number of second slots 123 defined in each of the first set 123′ and the second set 123″ of bearing bar 116.

As best seen in FIG. 8C, the transverse bars 118 of bar assembly 114 includes a third transverse bar 126 having a front 126A and a back 126B opposite one another. The third transverse bar 126 further includes a top 126C and a bottom 126D opposite and spaced a distance apart from one another, where the space between the top 126C and the bottom 126D defines a seventh height “H7” of the third transverse bar 126. The third transverse bar 126 further includes a left side 126E and a right side 126F opposite and spaced apart one another, where the space between the left side 126E and the right side 126F defines a seventh thickness “T7” of the third transverse bar 126. Third transverse bar 126 is sized so that height “H7” and thickness “T7” thereof are only marginally smaller than the seventh height “H7” and seventh width “W7” of the third slots 125 defined in bearing bar 116. It will be understood that although bar assembly 114 as illustrated herein includes three third transverse bars 126, bar assembly 114 may alternatively have any other desired number of third transverse bars 126.

In one embodiment, the seventh height “H7” is between 1.75-2.25 inches. More specifically, seventh height “H7” is between 1.75-2.25 inches. Most specifically, seventh height “H7” is about 2 inches. In one embodiment, seventh thickness “T7” is between 0.075-0.3 inches. More specifically, seventh thickness “T7” is between 0.15-0.225 inches. Most specifically, seventh thickness “T7” is about 0.1875 inches.

As best seen in FIG. 9, the plurality of slots 120 defined in bearing bar 116 are of a size and shape to complement a respective one of the plurality of transverse bars 118 and to receive the complementary transverse bars 118 therein.

It will be understood that the measurements detailed below are exemplary in nature, but it should be understood that a grating incorporating bar assembly 114 will include bearing bars 116 and transverse bars 118 that are sized and placed in a location relative to one another in a similar matter to the below measurements on a proportional basis.

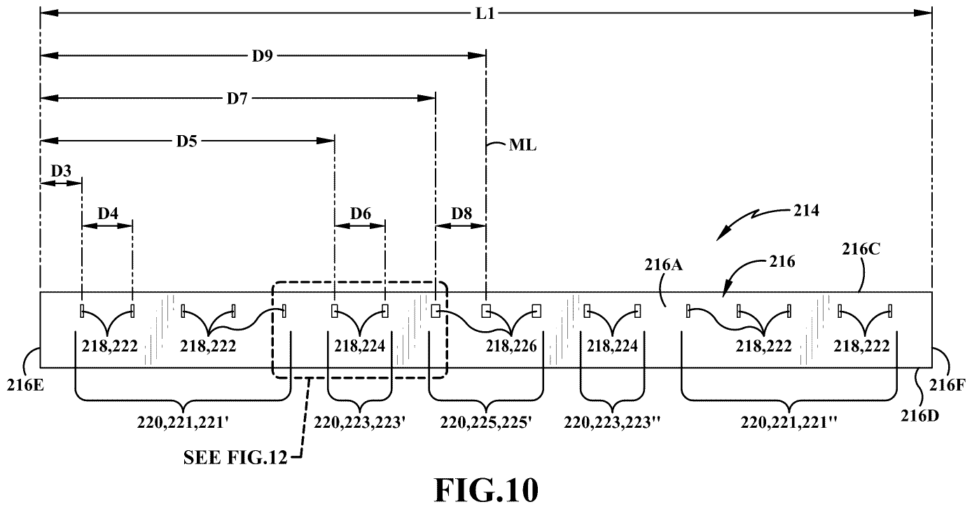

Referring now to FIGS. 10-12, there is shown a third embodiment of a bar assembly 214 in accordance with an aspect of the present disclosure. Bar assembly 214 comprises a plurality of third embodiment bearing bars 216 and a third arrangement of a plurality of transverse bars 118.

A grating produced with bar assembly 214 will be substantially identical to grating 10. Bar assembly 214 includes a plurality of bearing bars 216 substantially identical in structure and function to bearing bars 16 and bearing bars 116, except for the size and location of at least some of a plurality of slots 220 defined in bearing bars 216 relative to the slots 20 defined in bearing bars 16 or the slots 120 defined in bearing bars 116. The plurality of transverse bars 118 is substantially identical to the plurality of transverse bars 18 and the plurality of transverse bars 118 except that each one of the plurality of transverse bars 218 is configured, i.e., shaped and sized, to be engageable with the plurality of slots 220 in bearing bars 116.

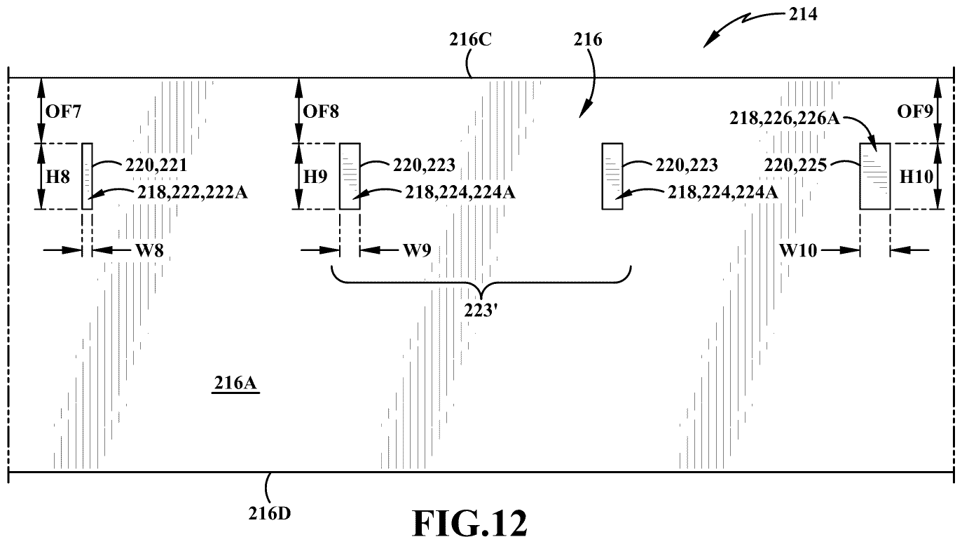

As best seen in FIGS. 10 and 12, bearing bar 216 defines a plurality of first slots 221, a plurality of second slots 223, and a plurality of third slots 225. The plurality of first slots 221 are arranged in a first set 221′ located proximate left side 216E of bearing bar 216 and a second set 221″ located proximate right side 216F of bearing bar 216. First and second sets set 221′, 221″ of first slots 221 are substantially identical in structure and function to first and second sets 21′, 21″ of first slots 21 of bearing bar 16. As shown in FIG. 12, each first slot 221 is of an eighth height “H8”, of an eighth width “W8”, and the top of the slot 221 is located at a seventh offset “OF7” from the top 216C of bar 216.

In one embodiment, the eighth height “H8” of first slot 221 on bearing bar 216 is substantially equal to the second height “H2” (FIG. 4A) of first slot 21e on bearing bar 16, the eighth width “W8” of first slot 221 on bearing bar 216 is substantially equal to the second width “W2” of first slot 21e on bearing bar 16, and the seventh offset “OF7” of first slot 221 on bearing bar 216 is substantially equal to the first offset “OF1” of first slot 21e on bearing bar 16.

Referring still to FIGS. 10 and 12, the plurality of second slots 223 defined in bearing bar 216 are arranged in a first set 223′ located proximate the first set 221′ of first slots 221 and a second set 223″ located proximate the second set 221″ of first slots 221. First and second sets 223′, 223″ of second slots 223 on bearing bar 216 are substantially identical in function to first and second sets 23′, 23″ of second slots 23 of bearing bar 16. As shown in FIG. 12, each second slot 223 is of a ninth height “H9”, is of a ninth width “W9”, and the top end of each second slot 223 is located at an eighth offset “OF8” from the top 216C of bearing bar 216.

In one embodiment, the ninth height “H9” of second slots 223 on bearing bar 216 is substantially equal to the eighth height “H8” of first slots 221 instead of being of a greater height relative thereto. Bearing bar 216 further differs from bearing bars 16 and 116 in that the ninth width “W9” of second slots 223 on bearing bar 216 is greater than the eighth width “W8” of the first slots 221. In bearing bars 16 and 116, the width of the second slots 23, 123 is substantially the same as the width of the first slots 21, 121. The eighth offset “OF5” of second slots 223 on bearing bar 216 is substantially equal to the eighth offset “OF8” of first slots 221 on bearing bar 216 and to the third offset “OF3” of third slots 23 on bearing bar 16.

The plurality of third slots 225 defined in bearing bar 216 is arranged in a single set 225′ located intermediate the first and second sets 223′, 223″ of second slots 223. This arrangement is similar to how the first set 25′ of third slots 25 is located intermediate first and second sets 23′, 23″ of second slots 23 in bearing bar 16. The top ends of third slots 225 are located a ninth offset “OF9” from top 216C of bearing bar 216. The ninth offset “OF9” may be substantially equal to the eight offset “OF8” of second slots 221 and to the third offset “OF3” (FIG. 4A) of third slots 25 on bearing bar 16. Third slots 225 on bearing bar 216 differ from third slots 25 on bearing bar 16 in that the tenth height “H10” of each third slot 225 is substantially equal to the eighth height “H8” of first slots 221 and the ninth height “H9” of second slots 223 instead of being of a greater height relative thereto. The third slots 225 differ further from third slots 25 in that the tenth width “W10” of the third slots 125 is greater than the ninth width “W9” of second slots 223 and is greater than the eighth width “W8” of first slots 221 instead of being of substantially the same width.

It should be noted that the third arrangement of slots 220 defined in bearing bar 216 shown in FIG. 10 places the various slots 220 at the same distances “D3” through “D9” as the slots 20 in bearing bar 16 shown in FIG. 4. In other embodiments, these distances “D3” through “D9” may differ from the distances illustrated in FIG. 10.

Referring now to FIG. 11, the plurality of transverse bars 218 of the bar assembly 214 comprises three types of transverse bars, namely, a first transverse bar 222, a second transverse bar 224 and a third transverse bar 226. The plurality of transverse bars 218 utilized in bar assembly 214 may have any number of first transverse bars 222, second transverse bars 224 and/or third transverse bars 226. The number and configuration of each of the first, second and third transverse bars 222, 224, 226 within the plurality of transverse bars 218 is selected to be complementary to the configuration of the bearing bars 216 and vice versa.

Referring to FIGS. 10 and 11A, the bar assembly 214 includes the two sets of five first transverse bars 222 which correspond in configuration to first and second sets set 221′, 221″ of first slots 221; two sets of two second transverse bars 224 which correspond in configuration to first and second sets 223′, 223″ of second slots 223, and one set of third transverse bars 226 which correspond in configuration to the single set of third slots 225.

As best seen in FIGS. 10 and 11A, the first transverse bar 222 has a front 222A and a back 222B opposite one another. The first transverse bar 222 further includes a top 222C and a bottom 222D opposite and spaced a distance apart from one another, where the space between the top 222C and the bottom 222D defines the eighth height “H8” of the first transverse bar 222. The first transverse bar 222 further includes a left side 222E and a right side 222F opposite and spaced apart one another, where the space between the left side 222E and the right side 222F defines an eighth thickness “T8” of the first transverse bar 222. It will be understood that the eighth height “H8” and eighth thickness “T8” are sufficiently small enough for first transverse bars 222 to be received in the complementary first slots 221 of bearing bar 216.

In one embodiment, eighth height “H8” is between 0.5-1.5 inches. More specifically, eighth height “H8” is between 0.75-1.25 inches. Most specifically, eighth height “H8” is about 1 inch. In one embodiment, eighth thickness “T8” is between 0.05-0.2 inches. More specifically, eighth thickness “T8” is between 0.1-0.15 inches. Most specifically, the eighth thickness “T8” is about 0.125 inches.

It will be understood that although bar assembly 214 as illustrated herein includes five first transverse bars 222 to be inserted into the first set 221′ of first slots 221 in bearing bar 216, and five first transverse bars 222 to be inserted into the second set 221″ of first slots 221, bar assembly 214 may alternatively have any other number of first transverse bars 222 for engagement in a complementary number and configuration of first slots 221.

Referring now to FIGS. 10 and 11B, the bar assembly 214 further includes a pair of second transverse bars 224 for engagement in the first set 223′ of second slots 223 in bearing bar 216 and a pair of second transverse bars 224 for engagement in the second set 223″ of second slots 223.

As best seen in FIG. 11B, the second transverse bar 224 has a front 224A and a back 224B opposite one another. The second transverse bar 224 further includes a top 224C and a bottom 224D opposite and spaced a distance apart from one another, where the space between the top 224C and the bottom 224D defines the ninth height “H9” of the second transverse bar 224. The second transverse bar 224 further includes a left side 224E and a right side 224F opposite and spaced apart one another, where the space between the left side 224E and the right side 224F defines a ninth thickness “T9” of the second transverse bar 224. It will be understood that the ninth height “H9” and ninth thickness “T9” are sufficiently small enough for second transverse bars 224 to be received in the complementary second slots 22e of bearing bar 216.

In one embodiment, ninth height “H9” is between 0.5-1.5 inches. More specifically, ninth height “H9” is between 0.75-1.25 inches. Most specifically, ninth height “H9” is about 1 inch. In one embodiment, ninth thickness “T9” is between 0.1-0.4 inches. More specifically, ninth thickness “T9” is between 0.2-0.3 inches. Most specifically, ninth thickness “T9” is about 0.25 inches.

It will be understood that although bar assembly 214 as illustrated herein includes four second transverse bars 224 for engagement in the second slots 223 of the bearing bar 216, bar assembly 214 may alternatively have any number of second transverse bars 224 for engagement in the second slots 223.

Referring now to FIGS. 10 and 11C, the bar assembly 214 further includes three third transverse bars 226 which are to be located between the two pairs of second transverse bar 226 when the transverse bars 218 are engaged with bearing bar 216. As best seen in FIG. 11C, the third transverse bar 226 has a front 226A and a back 226B opposite one another. The third transverse bar 226 further includes a top 226C and a bottom 226D opposite and spaced a distance apart from one another, where the space between the top 226C and the bottom 226D defines the tenth height “H10” of the third transverse bar 226. The third transverse bar 226 further includes a left side 226E and a right side 226F opposite and spaced apart one another, where the space between the left side 226E and the right side 226F defines a tenth thickness “T10” of the third transverse bar 226. It will be understood that the tenth height “H10” and tenth thickness “T10” are sufficiently small enough for third transverse bars 226 to be received in the complementary third slots 225 of bearing bar 216.

In one embodiment, tenth height “H10” is between 0.5-1.5 inches. More specifically, tenth height “H10” is between 0.75-1.25 inches. Most specifically, tenth height “H10” is about 1 inch. In one embodiment, tenth thickness “T10” is between 0.15-0.6 inches. More specifically, tenth thickness “T10” is between 0.3-0.45 inches. Most specifically, tenth thickness “T10” is about 0.375 inches.

It will be understood that although bar assembly 214 as illustrated herein includes three third transverse bars 226, bar assembly 214 may alternatively have any other desired number of third transverse bars 226.

As best seen in FIG. 12, each of the plurality of slots 220 defined in bearing bar 216 is of a size and shape to complement a respective one of the plurality of transverse bars 218. The number of slots 220 defined in the bearing bars 216 and the shape, height, and width thereof are selected to be complementary to the number, shape, height, and thickness of the transverse bars to be engaged therewith. The specific number of slots 220, their configuration and placement in bearing bars 216 and the complementary number of transverse bars 218, their configuration and engagement in bearing bars 216 are selected based on the specific application of the grating which includes bar assembly 214.

It will be understood that the measurements detailed below are exemplary in nature, but it should be understood that the grating which includes bar assembly 214 will include bearing bars 216 and transverse bars 218 that are sized and placed in a location relative to one another in a similar matter to the below measurements on a proportional basis.

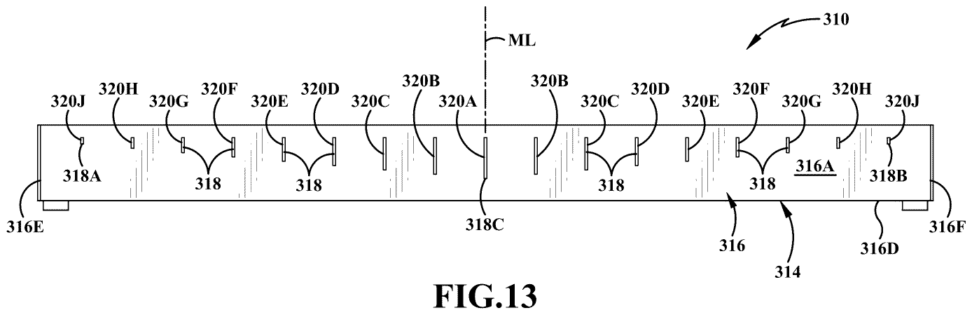

Referring now to FIG. 13, there is shown a four embodiment of a bar assembly 314 in accordance with an aspect of the present disclosure. Bar assembly 314 comprises a fourth embodiment of a plurality of bearing bars 316 and a complementary fourth arrangement of a plurality of transverse bars 318 for engagement with bearing bars 316. Bar assembly 314 is substantially identical to bar assembly 14, bar assembly 114 and bar assembly 214 for use in a grating except for an arrangement of a plurality of slots 318 defined in the bearing bars 316 and for the complementary configuration of transverse bars 318 for engagement with the bearing bars 316. The plurality of bearing bars 316 is substantially identical in structure and function to plurality of bearing bars 16, plurality of bearing bars 116, and plurality of bearing bars 216, except for the size and location of a plurality of slots 320 defined therein. The plurality of transverse bars 318 is substantially identical to the plurality of transverse bars 18, the plurality of transverse bars 118 and the plurality of transverse bars 218 except for the size and configuration of each one of the plurality of transverse bars 318.

Referring to FIGS. 13, each bearing bar defines a plurality of slots 320 therein. A centermost slot 320A is oriented along a midline “ML” of bearing bar. The centermost slot 320A is of a height and a width.

A pair of slots 320B flank slot 320A. Each of the slots 320B is of a height and a width, where the height is smaller than the height of the centermost slot 320A. The width of each of the slots 320B is substantially equal to the width of the centermost slot 320A.

A further pair of slots 320C flank slots 320B. Each of the slots 320C is of a height and a width, where the height is smaller than the height of each of the slots 320B. The width of each of the slots 320C may be substantially equal to the width of the centermost slot 320A.

A further pair of slots 320D flank slots 320C. Each of the slots 320D is of a height and a width, where the height is smaller than the height of each of the slots 320C. The width of each of the slots 320D may be substantially equal to the width of the centermost slot 320A.

A further pair of slots 320E flank slots 320D. Each of the slots 320E is of a height and a width, where the height is smaller than the height of each of the slots 320D. The width of each of the slots 320E may be substantially equal to the width of the centermost slot 320A.

A further pair of slots 320F flank slots 320E. Each of the slots 320F is of a height and a width, where the height is smaller than the height of each of the slots 320E. The width of each of the slots 320F may be substantially equal to the width of the centermost slot 320A.

A further pair of slots 320G flank slots 320F. Each of the slots 320G is of a height and a width, where the height is smaller than the height of each of the slots 320F. The width of each of the slots 320G may be substantially equal to the width of the centermost slot 320A.

A further pair of slots 320H flank slots 320G. Each of the slots 320H is of an height and an width, where the height is smaller than the height of each of the slots 320G. The width of each of the slots 320H may be substantially equal to the width of the centermost slot 320A.

A further pair of slots 320J flank slots 320H and is interposed between slots 320H and the respective one of the left side 316E and right side 316F of bearing bar 316. Each of the slots 320Y is of a height and a width, where the height is smaller than the height of each of the slots 320H. The nineteenth width may be substantially equal to the width of the centermost slot 320A.

It will be understood that each of the slots 320A through 320J is offset at a same offset distance from top 316A of bearing bar 316.

The plurality of transverse bars 318 includes a first transverse bar 318A located proximate to a left side 316E of the plurality of bearing bars 316 and a second transverse bar 318B located proximate to a right side 316F of the plurality of bearing bars 316. The first transverse bar 318A and the second transverse bar 318B are identical in size and shape to one another and are shaped and sized to be complementary to slots 320J in bearing bar 316. A third transverse bar or a middle transverse bar 318C is complementary in size and shape to the centermost slot 320A defined in bearing bar 316. Each one of the plurality of transverse bars 318 located between the first transverse bar 318A and the middle transverse bar 318C incrementally increases in size moving from the first transverse bar 318A to the middle transverse bar 318C. Each one of the plurality of transverse bars 318 located between the middle transverse bar 318C and the second transverse bar 318B decreases incrementally in size moving from middle transverse bar 318C to second transverse bar 318B. Each one of the plurality of transverse bars 318 between the first transverse bar 318A and the middle transverse bar 318 and between the middle transverse bar 318 and the second transverse bar 318A is configured to be complementary to one of the pairs of slots 320B to 320G. When bar assembly 314 is assembled, each one of the plurality of transverse bars 318 is received through a complementary slot 320 defined in the plurality of bearing bars 316 and is suitable secured in place.

Unless explicitly stated that a particular shape or configuration of a component is mandatory, any of the elements, components, or structures discussed herein may take the form of any shape. Thus, although the figures depict the various elements, components, or structures of the present disclosure according to one or more exemplary embodiments, it is to be understood that any other geometric configuration of that element, component, or structure is entirely possible. For example, instead of the bearing bars and cross bars being rectangular, the bearing bars 16 and transverse bars 18 can be semi-circular triangular, rectangular or square, pentagonal, hexagonal, heptagonal, octagonal, decagonal, dodecagonal, diamond shaped or another parallelogram, trapezoidal, star-shaped, oval, ovoid, lines or lined, teardrop-shaped, cross-shaped, donut-shaped, heart-shaped, arrow-shaped, crescent-shaped, any letter shape (i.e., A-shaped, B-shaped, C-shaped, D-shaped, E-shaped, F-shaped, G-shaped, H-shaped, I-shaped, J-shaped, K-shaped, L-shaped, M-shaped, N-shaped, O-shaped, P-shaped, Q-shaped, R-shaped, S-shaped, T-shaped, U-shaped, V-shaped, W-shaped, X-shaped, Y-shaped, or Z-shaped), or any other type of regular or irregular, symmetrical or asymmetrical configuration.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc. As another example, “at least one of: A, B, or B” is intended to cover A, B, C, A-B, A-C, B-C, and A-B-C, as well as any combination with multiple of the same item.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present disclosure.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments. Furthermore, the use of any and all examples or exemplary language (“e.g.,” “such as,” or the like) is intended merely to better illustrate or illuminate the embodiments and does not pose a limitation on the scope of that or those embodiments. No language in this specification should be construed as indicating any unclaimed element as essential to the practice of the disclosed embodiment.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element or “another” element, that does not preclude there being more than one of the additional element or the another element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein. Further, recitation of ranges of values herein are not intended to be limiting, referring instead individually to any and all values falling within that range, unless otherwise indicated herein, and each separate value within such range is incorporated into the specification as if it were individually recited herein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, or in the context of those sections, this term has been included as required by the formatting requirements of word document submissions (i.e., docx submissions) pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A method of forming a grating comprising:
providing a plurality of bearing bars;
providing a plurality of transverse bars with different dimensions from one another;
determining a weak point of the grating along a span of the grating;
engaging a transverse bar with a largest dimension of the plurality of transverse bars with each of the plurality of bearing bars at the weak point of the grating; and
engaging each transverse bar with a smaller dimension of the plurality of transverse with each of the plurality of bearing bars.

2. The method according to claim 1, further comprising:
determining a second weak point of the grating along the span of the grating; and
engaging a transverse bar with a second largest dimension of the plurality of transverse bars with each of the plurality of bearing bars at the second week point of the grating.

3. The method according to claim 2, further comprising:
determining one or more additional weak points of the grating along the span of the grating; and
engaging a transverse bar with one or more dimensions which are smaller than the largest dimension and smaller than the second largest dimension with each of the plurality of bearing bars at the one or more additional weak points.

4. The method according to claim 1, further comprising:
defining a plurality of slots in each bearing bar of the plurality of bearing bars;
forming the plurality of slots with different dimensions from one another which are complementary to the different dimension of plurality of transverse bars; and
inserting each transverse bar into a complementary slot of the plurality of slots.

5. The method according to claim 2, wherein inserting each transverse bar is preceded by:
arranging the plurality of bearing bars in parallel with one another; and
aligning the plurality of slots in the plurality of bearing bars with one another.

6. The method according to claim 2, wherein forming the plurality of slots with different dimensions comprises:
forming the plurality of slots with different heights as measured from a top to a bottom of the plurality of slots.

7. The method according to claim 6, wherein forming the plurality of slots with different dimensions comprises:
defining an offset for each of the plurality of slots where the offset is measured from a top of the plurality of bearing bar.

8. The method according to claim 1, wherein providing the plurality of transverse bars with different dimensions comprising:
providing the plurality of transverse bars with different heights as measured from a top to a bottom of the plurality transverse bars.

9. The method according to claim 5, wherein inserting each transverse bar of the plurality of transverse bars into a complementary slot of the plurality of slots comprises:
inserting a transverse bar of the plurality of transverse bars with a greatest height into a slot of the plurality of slots with a greatest height located along a midline of the plurality of bearing bars.

10. The method according to claim 4, further comprising:
forming at least a first slot of the plurality of slots with a first dimension;
forming at least a second slot of the plurality of slots with a different second dimension;
forming at least a first transverse bar of the plurality of transverse bars with a complementary dimension to the first dimension; and
forming at least a second transverse bar of the plurality of transverse bars with a complementary dimension to the second dimension.

11. The method according to claim 10, further comprising:
forming one or more additional slots of the plurality of slots with one or more additional dimensions; and
forming one or more additional transverse bars of the plurality of transverse bars each with a complementary dimension to the one or more additional dimensions.

12. The method according to claim 11, further comprising:
locating the first slot of the plurality of slots proximate a left side or a right side of each of the plurality of bearing bars;
locating the second slot of the plurality of slots between the first slot and a midline of the plurality of bearing bars; and
locating the one or more additional slots along the midline of the plurality of bearing bars.

13. The method according to claim 10, further comprising:
forming at least a third slot of the plurality of slots with a third dimension;
wherein the third dimension is larger than the first dimension and the second dimension and the second dimension is larger than the first dimension; and
forming at least a third transverse bar of the plurality of transverse bars with a complementary dimension to the third dimension.

14. The method according to claim 10, wherein forming at least a first slot of the plurality of slots with a first dimension comprises:
defining a first offset for the first slot where the first offset is measured from a top of the plurality of bearing bar.

15. The method according to claim 10, wherein forming at least a second slot of the plurality of slots with a different second dimension comprises:
defining a second offset for the second slot where the second offset is measured from the top of the plurality of bearing bar.

16. The method according to claim 13, wherein forming at least a third slot of the plurality of slots with a different third dimension comprises:
defining a third offset for the third slot where the third offset is measured from the top of the plurality of bearing bar.

17. The method according to claim 10, further comprising:
locating the first slot of the plurality of slots proximate a left side or a right side of each of the plurality of bearing bars; and
locating the second slot of the plurality of slots between the first slot and a midline of the plurality of bearing bars.

18. The method according to claim 17, further comprising:
inserting the first transverse bar of the plurality of transverse bars into the first slot with the first dimension of the plurality of slots;
inserting the second transverse bar of the plurality of transverse bars into the second slot with the second dimension of the plurality of slots; and
wherein the second dimension is larger than the first dimension.

19. The method according to claim 17, further comprising:
locating the third slot along the midline of the plurality of bearing bars.

20. The method according to claim 19, further comprising:
inserting the third transverse bar of the plurality of transverse bars into the third slot with the third dimension of the plurality of slots; and
wherein the third dimension is larger than the first dimension and the second dimension.
